(19) United States
(12) Patent Application Publication
(10) Pub. No.: US 2012/0125590 A1
(43) Pub. Date: May 24, 2012

(54) TEMPERATURE CONTROL MEDIUM AND TEMPERATURE CONTROL METHOD

(75) Inventors: WERNER GUCKERT, BAAR (DE); AXEL WINKLER, RHEURDT (DE); DIRK HEUER, TAUBERBISCHOFSHEIM (DE); CHRISTIAN KIPFELSBERGER, NAILA (DE)

(73) Assignee: SGL CARBON SE, WIESBADEN (DE)

(21) Appl. No.: 13/329,659

(22) Filed: Dec. 19, 2011

Related U.S. Application Data
(63) Continuation of application No. PCT/EP2010/003683, filed on Jun. 18, 2010.

(30) Foreign Application Priority Data
Jun. 18, 2009 (DE) 10 2009 029 758.8

(51) Int. Cl. F28F 7/00; C09K 5/10

(52) U.S. Cl. 165/185; 252/71; 252/74

(57) ABSTRACT

A temperature control medium is formed of a liquid and solid particles, the solid particles containing carbon particles. The amount of carbon in the temperature control medium is preferably less than 20% by weight. The carbon particles may contain synthetic graphite, natural graphite, soot, carbon fibers, graphite fibers or expanded graphite or a mixture of at least two of these elements.

### CROSS-REFERENCE TO RELATED APPLICATION

This application is a continuation, under 35 U.S.C. §120, of copending international application No. PCT/EP2010/003683, filed Jun. 18, 2010, which designated the United States; this application also claims the priority, under 35 U.S.C. §119, of German patent application No. DE 10 2009 029 758.8, filed Jun. 18, 2009; the prior applications are herewith incorporated by reference in their entirety.

### BACKGROUND OF INVENTION

1. Field of the Invention

The present invention relates to a thermally and electrically conductive liquid and the production and use thereof.

Liquids for transferring heat or cold—referred to below as temperature control media—can be found in many fields. Examples are industrial processes, systems, machinery, engines, technical apparatus, air conditioning of buildings, and the exploitation of geothermal and solar energy. Demands made of the respective cold and heat transfer media are increasing all the time.

In addition to water, which is a preferred medium for temperature control tasks owing to its thermophysical properties, specific liquids for example based on multivalent alcohols such as propylene glycol are used, depending on the temperature level and viscosity requirements for the respective application.

For many applications and for the protection of pipe systems through which liquid is conducted and of pumps and the like, additives such as salts, silicates, dispersants, UV-stabilizers, antifreeze agents, anticorrosives, inhibitors and others are added to temperature control media, e.g. water and alcohols. Due to this usually essential addition of additives, temperature control media with significantly reduced thermal conductivity are produced. Conventional water still has a thermal conductivity of approximately 0.58 W/mK, while the thermal conductivity in liquid mixtures which are currently conventionally used as heat or cold transfer media lies as low as within a range from approximately 0.02-0.25 W/mK.

Efforts are therefore being made to increase the thermal conductivity of such conventional temperature control media.

To this end, liquids which increase the thermal conductivity are added to the liquid temperature control media to produce emulsions, or suspensions with solids. The use of solids such as metal powders of high thermal conductivity such as copper or aluminium has however serious disadvantages. For instance, the metal powders settle out very quickly owing to the density of conventional temperature control media, between approximately 0.60 and 1.20 g/cm³, have a highly abrasive effect on pipes and pumps, and sometimes react chemically with the liquid temperature control media or especially with the additives. For example, copper particles react very strongly with salts.

For this reason, research is concentrated on introducing solids of high thermal conductivity into the temperature control liquid as nanopowders. This is intended to counteract very rapid settling and severe abrasion. The disadvantage of this is however the high complexity of producing such powders and the costs arising thereby. Moreover, nanopowders tend to agglomerate, which must also be prevented with a great deal of effort. In addition, very large amounts of more than 5-10% by weight of nanopowder must be added for a significant increase in thermal conductivity, according to initial studies.

### SUMMARY OF INVENTION

It is accordingly an object of the invention to provide a temperature control medium which overcomes the above-mentioned disadvantages of the heretofore-known devices and methods of this general type and which provides for an easily produced temperature control medium of high thermal conductivity which does not cause abrasion and which is chemically relatively inert.

With the foregoing and other objects in view there is provided, in accordance with the invention, a temperature control medium, comprising:

a liquid; and

solid particles containing carbon particles in said liquid.

In other words, the objects of the invention are achieved by a temperature control medium that contains carbon particles as the solid which increases thermal conductivity. Carbon has high thermal conductivity, settles out only slowly in a liquid due to its low density, and causes practically no abrasion. Furthermore, carbon is chemically inert, so it does not change into chemically aggressive liquids or react with additives and thus does not affect the properties of the liquid. Furthermore, the temperature control medium according to the invention is inexpensive and does not require any conversion of existing systems, or at most only minor ones. This applies for example to pipe cross sections and pump outputs.

The proportion of carbon particles in the temperature control medium is advantageously less than 20% by weight, preferably less than 10% by weight, in particular less than 5% by weight. A proportion between 0.1 and 2% by weight is particularly advantageous. Previously, efforts were made in the technical literature to achieve a high number of contacts between the particles in a bridge- or framework-like manner in order to achieve a greatly increased thermal conductivity upwards of a certain threshold value. In contrast to this, a temperature control medium according to the invention has no threshold value in relation to the proportion of carbon particles, so the thermal conductivity is surprisingly very high even at the preferred low proportions of carbon in the liquid mentioned. The present invention however of course also includes much higher proportions of carbon particles of for example up to 50% by weight and above, even up to 70 or 95% by weight.

Surprisingly, the heat transfer through a temperature control medium according to the invention is also very high in the moving state, as the heat is not only transferred continuously, but is especially transferred by individual impacts of carbon particles against the walls of a container, such as a pipe, in which the temperature control medium is contained for the purposes of heat or cold transfer. Individual carbon particles thus act as temperature transfer media, which transport heat or cold between each other and to the walls.

The liquid of the temperature control medium is preferably a liquid from the group consisting of water, alcohols such as propanol, glycerol, glycol such as ethylene glycol or propylene glycol, and hydrocarbons such as those based on mineral oils, silicone oils, hydrated oils, petroleum, paraffins or naphtha-based oils, silicone oils or the like, esters or ethers such as phosphate ester and aromatics or a mixture of at least two such liquids.

Water has the advantage that it is an inexpensive, readily available liquid of suitable viscosity, which in addition to e.g. mercury has the highest conductivity of all liquids.

Alcohols have the advantage that they do not solidify in the typical use range between minus 60° C. and 300° C. and therefore antifreeze agents do not have to be added to them.

Hydrocarbons likewise do not solidify in the typical use range between 60° C. and 300° C. and have the further advantage that they act as lubricants.

According to a further aspect of the invention, additives such as salts, silicates, dispersants, UV stabilizers, antifreeze agents, anticorrosives and inhibitors are added to the liquid. Typical antifreeze agents are glycol, such as ethylene glycol and propylene glycol, and salts, for example those based on potassium formate or potassium propionate.

Furthermore, liquefied gases such as nitrogen at −196° C. can also be used advantageously as the liquid of the temperature control medium according to the invention. Such liquids also have the above-mentioned advantages.

Furthermore, according to a further preferred variant of the invention, the liquid is a melt, in particular a polymer melt. This is particularly suitable as the liquid at high temperatures such as those arising in solar thermal systems. The polymers considered include in particular thermoplastics such as polyethylene, polypropylene, polystyrene, polyvinyl chloride and similar thermoplastics and compounds of at least two of these polymers. These can be used for example in temperature ranges of between 180 and 450° C., depending on their melting point and the temperature above which they decompose. Such melts have the advantage of low vapour pressure at high temperatures.

Carbon particles which are preferably used are particles containing synthetic graphite, natural graphite, carbon black, carbon fibers, graphite fibers or expanded graphite. The particles can be present in the form of flocks, powder, granules and agglomerate or flakes. Flakes are pieces of expanded graphite film of approximately 5-10 mm edge length.

Expanded graphite is produced by expanding graphite, usually by means of acid and temperature and is usually in the form of flocks. Expanded graphite and the production thereof are known to a person skilled in the art and are therefore not described in any more detail at this point. Graphite film is produced by at least partial recompression of expanded graphite and is likewise known from the literature.

Expanded graphite within the context of the invention also means ground, at least partially compressed expanded graphite. This is for example graphite film which is comminuted in a grinding process. In addition to the comminution, the particles of expanded graphite are at least partially recompressed, so that ground expanded graphite has a higher density compared to non-ground expanded graphite, of between 0.1 and 1.8 g/cm³, preferably between 0.4 and 1.4 g/cm³.

Comminuted pieces of graphite film can likewise be used as what are known as flakes within the context of the invention. The use of graphite film pieces in particular has the advantage of being able to use residual pieces of graphite film during the production or reprocessing thereof.

Expanded graphite has the advantage of a particularly low density, which results in a long suspension of the particles in the liquid. Settling particles are swirled up again by even slight movements such as convection. A particularly homogeneous temperature control medium which is stable in the long term is thus produced.

It is particularly advantageous to use or produce expanded graphite which is treated with plasma. The plasma treatment increases the affinity of the graphite particles, which are in themselves non-polar, with polar liquids such as water and thereby improves the mixing behavior.

The carbon particles advantageously have a size distribution between 1 μm and 15 mm, particularly preferably between 2 μm and 10 mm, in particular between 50 μm and 1 mm.

For carbon fibers as the carbon particles, this size information applies correspondingly to the length. Long fibers of up to 50 mm in length, in particular up to 30 mm, in particular up to 15 mm can however be used as the carbon fibers according to the invention.

Flocks consisting of expanded graphite which are advantageously used for a temperature control medium according to the invention likewise have a high ratio of length to thickness. The preferred length thereof is up to 20 mm, in particular up to 10 mm, in particular up to 5 mm. In particular after relatively long use of a temperature control medium with graphite flocks as carbon particles, the length thereof can however be only up to 3 mm, in particular up to 1 mm, due to the mechanical loading of the flocks. The preferred thickness or diameter thereof is between 100 and 1000 nm, in particular between 300 and 800 nm.

Such preferred particle sizes have the advantage that they can be produced with very little effort compared to very small particles such as nanoparticles. They can even be taken directly from the production process of for example expanded graphite without being further processed. At least, only minor comminution steps are necessary. The large particle sizes contained tend not to agglomerate, or at least only slightly, so that they remain in suspension for longer than smaller particles such as nanoparticles, which tend to join to form large agglomerates.

The density of the carbon particles used is preferably in a range between 0.05 and 2.2 g/cm³, particularly preferably between 0.1 and 1 g/cm³, in particular between 0.2 and 0.6 g/cm³. Correspondingly, the bulk density is preferably between 0.002 g/cm³ and 0.05 g/cm³, particularly preferably between 0.005 and 0.01 g/cm³. At such densities, hardly any settling out takes place; slight external influences easily bring the particles back into suspension. For carbon fibers, in particular for short fibers, the bulk density can also be much higher, e.g. at up to 1 g/cm³.

The production of a temperature control medium according to the invention takes place by mixing or stirring carbon particles within the meaning of the invention into the corresponding liquid. This can take place with conventional stirrers or mixers such as a friction mixer, or else simply manually. Known metering devices are also advantageously used. The production of the temperature control medium is very simple, as all the above-mentioned carbon particles can be easily mixed with the liquids mentioned without agglomerating. Plasma-treated particles have particularly good affinity with water, but all the other carbon particles used according to the invention also have very good mixing behavior. The temperature control medium according to the invention can thus be produced with little effort and low costs.

The object is also achieved with the use of a liquid containing carbon particles as a temperature control medium (also referred to as a heat transfer medium or cold transfer medium) to regulate a heat or cold balance. This comprises in particular the use in building services engineering, for technical systems, in apparatus construction, in vehicle and traffic technology, for example in relation to shipping and rail traffic, air and space travel and energy generation. Likewise in materials processing, where large quantities of heat arise and must be cooled, in particular metal and plastic processing, glass and ceramics processing, wood processing, but also the processing of fiber-like materials such as textile processing. Furthermore, a liquid with carbon particles can be used according to the invention in geothermal and solar thermal systems, in geothermal probes, heat pumps and heat recovery systems. Further uses according to the invention are in medical technology and super-conductivity technology, where cooling must take place with liquid gases at very low temperatures. Its chemical inertness and thus suitability for use with food allows it to be used in food technology, such as in cold-storage warehouses and vehicles for cooling foods, but also other perishable goods such as medicaments, blood and organs, etc.

In principle, the temperature control medium according to the invention can be used anywhere in the private and industrial fields where the removal, supply or transfer of heat or cold is desired. As well as the very good thermal conductivity, the many advantages of liquids with carbon particles also have an effect. In particular, carbon does not form any cleavage products even at high temperatures up to 500° C., is environmentally friendly, non-toxic and not hazardous to water, it remains stable during storage and transport, and does not react chemically with other additives in the liquid or with container walls. The viscosity of the base liquid is hardly affected at all and the ability to be pumped is very good. Surprisingly, the carbon particles also have a lubricating effect in the liquid, so the service life of pumps and other moving parts is even increased.

Particular advantages are the ease of maintenance, as the temperature control medium only has to be changed at very long maintenance intervals, if at all, owing to the low abrasion, low level of settling and the inertness of the carbon particles used. This is advantageous in particular for cooling circuits in nuclear power stations and geothermal systems, but applies just as much to heating systems of all kinds in private households, heat exchangers in the chemical industry or any other conceivable applications in which conventional temperature control media were previously used without the addition of carbon particles.

The embodiments and advantages mentioned above apply in principle to electrical conductivity as well as to thermal conductivity. However, it has been found according to the invention that the electrical conductivity rises even with relatively small quantities of carbon particles.

Other features which are considered as characteristic for the invention are set forth in the appended claims.

Although the invention is illustrated and described herein as embodied in a temperature control medium, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 A shows a measurement curve which shows the dependence of the thermal conductivity of a 1% suspension of graphite flocks according to the invention in still water compared to pure water within a temperature range from 20 to 80° C., in increments of 20° C.;

FIG. 1B shows a measurement curve which shows the dependence of the thermal conductivity of a 1% suspension of graphite flocks according to the invention in still water compared to pure water within a temperature range from 25 to 55° C., in increments of 5° C.;

FIG. 2 shows the amount of heat transferred, which has been determined by a simulation calculation, and the thermal conductivity of a temperature control medium according to the invention consisting of expanded graphite and water in the flowing state.

### DETAILED DESCRIPTION OF THE INVENTION

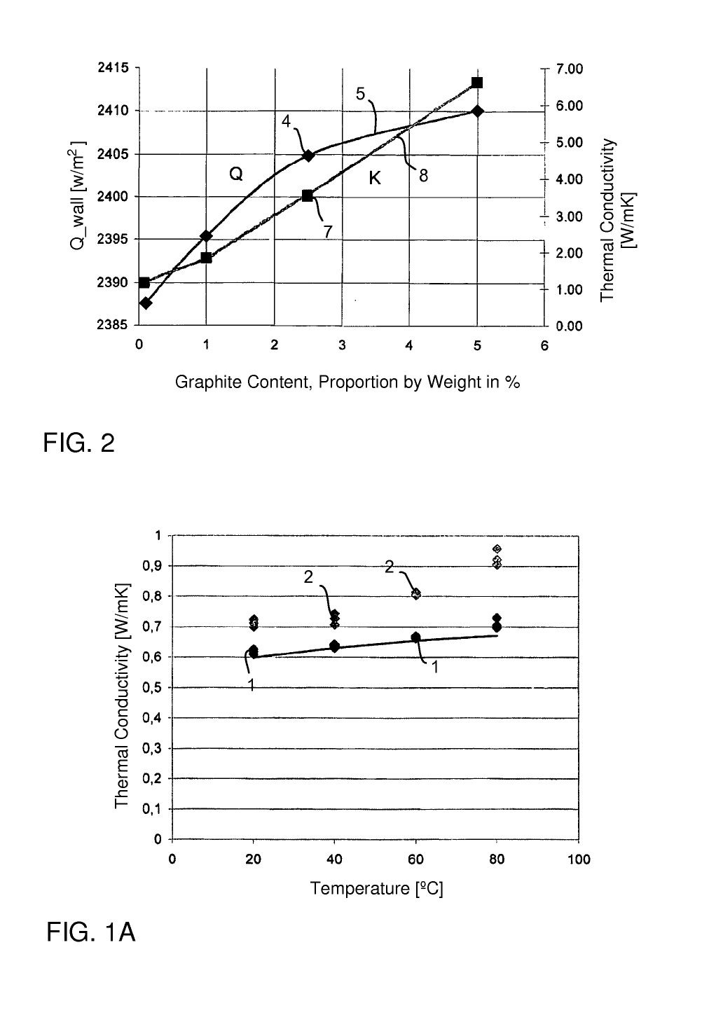

Referring now to the figures of the drawing in detail and first, particularly, to FIGS. 1A and 1B thereof, measurements were taken of the thermal conductivity of temperature control media according to the invention. FIGS. 1A and 1B show the results of the measurements. To this end, a 1% (by weight) suspension of graphite flocks consisting of expanded graphite was stirred into water. The flocks were on average in the region of approximately 3 mm in length and approximately 0.5 mm in diameter. Water without added carbon was measured as a comparison. The measurement was carried out on still temperature control media.

FIG. 1A shows in each case three measured values 1 for pure water and in each case three measured values 2 for the 1% suspension. A solid line 3 is also drawn in, which indicates the thermal conductivity of water from the literature. For both temperature control media, the thermal conductivity increases with an increase in temperature of from 20 to 80° C., but for a suspension according to the invention, the thermal conductivity is always above the thermal conductivity of water. The same applies to the measurements in FIG. 1B, where the data from FIG. 1A was verified with smaller measurement increments. The outstanding increase in thermal conductivity was approximately 30-50% even with the addition of only 1% by weight of carbon particles.

For moving temperature control media, a simulation calculation was carried out instead of a measurement.

The effective thermal conduction was calculated empirically using the Maxwell equation, the Maxwell-Garnett equation, and the equation according to Hamilton and Crosser.

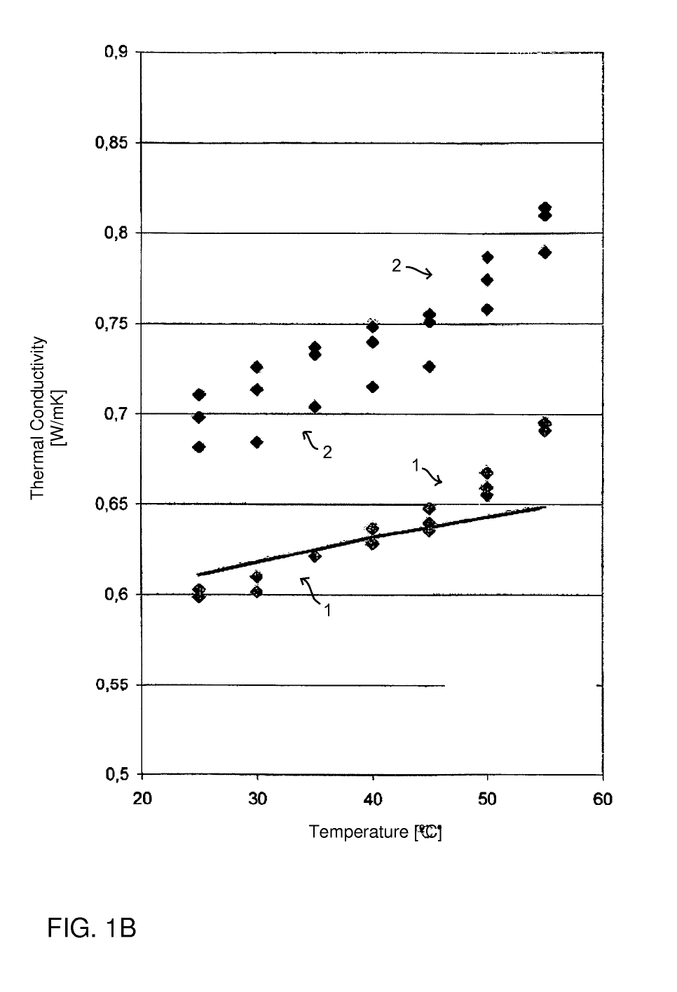

FIG. 2 shows the result of the simulation calculations. Various proportions by weight of graphite flocks were assumed and the thermal conductivity and the quantity of heat Q_{wall} transferred to the pipe walls were calculated. A starting temperature of the temperature control medium of 80° C. and a temperature of the pipe walls of 20° C. were assumed. The length of the pipe was 5 cm, the diameter 7 mm. The calculated values of the thermal conductivity are shown with small diamonds 4, through which a curve 5 is drawn, the values of the quantity of heat transferred are shown with large squares 7, through which a curve 8 is drawn. The quantity information of the x-axis is given in % by weight.

A rise in both the thermal conductivity and the quantity of heat Q_{wall} transferred to the pipe walls can be seen with an increasing quantity of carbon particles. The thermal conductivity of pure water of approximately 0.6 W/mK increases to almost ten times the value with 5% by weight of graphite flocks. Even at 1% by weight, the thermal conductivity is still much greater than with still, as is shown in FIGS. 1A and 1B. One reason for this may be the increased number of impacts of the graphite flocks on the pipe walls, which is caused by the flow. Correspondingly, a greater quantity of heat is transferred with an increasing quantity of graphite flocks.

1. A temperature control medium, comprising:
a liquid; and
solid particles containing carbon particles in said liquid.

2. The temperature control medium according to claim 1, wherein a proportion of carbon in the temperature control medium is less than 20% by weight.

3. The temperature control medium according to claim 1, wherein said liquid is at least one liquid selected from the group consisting of water, alcohols, and hydrocarbons.

4. The temperature control medium according to claim 3, which further comprises additives selected from the group consisting of antifreeze agents, anticorrosives, inhibitors, dispersants, and stabilizers added to the liquid.

5. The temperature control medium according to claim 1, wherein said liquid is a melt.

6. The temperature control medium according to claim 1, wherein said melt is a polymer melt.

7. The temperature control medium according to claim 1, wherein said carbon particles comprise graphitic materials selected from the group consisting of synthetic graphite, natural graphite, carbon black, carbon fibers, graphite fibers, and expanded graphite or a mixture of at least two of these elements.

8. The temperature control medium according to claim 7, wherein said carbon particles contain plasma-treated graphite.

9. The temperature control medium according to claim 1, wherein said carbon particles are particles in the form of flocks, powder, granules, agglomerate or flakes or said carbon particles have a mixture of at least two of these particle forms.

10. The temperature control medium according to claim 9, wherein said carbon particles contain plasma-treated graphite.

11. The temperature control medium according to claim 1, wherein said carbon particles have a distribution of size or length of between 1 μm and 2 mm, with carbon fibers having a length of up to 50 mm and with flakes having an edge length of up to 15 mm.

12. A temperature control method, comprising: providing a carbon particle-containing liquid and employing the carbon particle-containing liquid in a temperature control process as a temperature control medium.

13. The method according to claim 12, which comprises employing the temperature control medium in a heating or cooling system, in materials processing, as a hydraulic liquid, in vehicle technology, or in building systems engineering.

14. The method according to claim 12, which comprises employing the temperature control medium in geothermal or solar thermal systems, in geothermal probes, heat pumps or heat recovery systems.

15. The method according to claim 12, which comprises employing the temperature control medium in cooling systems of internal combustion engines, in medical technology, in building services engineering, energy generation or for cooling perishable goods.

16. A temperature control method, which comprises: providing the temperature control medium according to claim 1 and employing the carbon particle-containing liquid in a temperature control process as a temperature control medium.
